(19) United States
(12) Patent Application Publication
(10) Pub. No.: US 2013/0049608 A1
(43) Pub. Date: Feb. 28, 2013

(54) Adaptive Optics System for Harmonization and Balanced Lighting in Information Displays

(71) Applicants: Vanacan Tatavoosian, Mission Viejo, CA (US); Jie Jay Chang, Newbury Park, CA (US)

(72) Inventors: Vanacan Tatavoosian, Mission Viejo, CA (US); Jie Jay Chang, Newbury Park, CA (US)

(73) Assignee: Eaton Corporation, Cleveland, OH (US)

(21) Appl. No.: 13/512,104

(22) PCT Filed: Nov. 24, 2010
(86) PCT No.: PCT/US2010/058019

§ 371 Date: Oct. 23, 2012

Related U.S. Application Data
(60) Provisional application No. 61/264,509, filed on Nov. 25, 2009.

(51) Int. Cl. H05B 37/02

(52) U.S. Cl. 315/154

(57) ABSTRACT

A system for adaptively controlling and adjusting the output and balance of multiple integrated illuminated panels may include a plurality of illumination sources in operative connection with a plurality of integrated illuminated panels, the plurality of illumination sources being disposed within a vehicle cockpit. The system may also include a dimming control configured to provide manual adjustment of brightness of the plurality of illumination sources, and a digital controller configured to automatically harmonize chromaticity and brightness of the plurality of illumination sources based on detected ambient lighting conditions.

### CROSS-REFERENCE TO RELATED APPLICATION

This application is a national stage filing based upon International PCT Application No. PCT/US2010/058019, with an international filing date of Nov. 24, 2010, which claims the benefit of the filing date of U.S. Provisional Patent Application Ser. No. 61/264,509, filed Nov. 25, 2009, the entire disclosures of which is incorporated herein by reference.

### BACKGROUND

1. Technical Field

The present disclosure relates generally to adaptive lighting systems associated with information displays, and includes an adaptive optics systems for harmonization and balanced lighting associated with information displays.

2. Description of the Related Art

For information displays, such as aircraft cockpit illuminated panels and other man-machine interface devices, the desired level of brightness and color may vary from person to person. Light harmonization, which provides appropriate light brightness and color conditions among multiple illuminated panels in relation to the ambient lighting condition, is therefore desirable. Unbalanced lighting in an information display system can be distracting, especially when multiple illumination sources, such as illuminated aircraft cockpit panels, are not adjusted to consistent and/or proper levels of brightness and color. Unbalanced lighting conditions, coupled with long working hours, may also promote fatigue and increase the chances of a mistake. Balanced, harmonized lighting, tailored to the preferences of a particular person, in the man-machine environment may reduce fatigue and error, especially in critical work environments such as an aircraft cockpit.

Conventional industrial or aircraft cockpit control panel (CCP) systems are based on assembly of many individual panels, provided in parallel, with each performing as an individual “cell panel” for specific functions of user interface and control. Present CCP systems are not configured for adequate color balance and/or color compensation by modulating the light spectrum and/or brightness in a cockpit control panel system with multiple illuminated panels. Accordingly, it is desirable for aircraft, particularly large aircraft, to provide color and brightness harmonization in the cockpit based on the ambient lighting conditions as well as the preferences of a particular person.

Among other things, the present disclosure attempts to address one or more of the aforementioned challenges.

### SUMMARY

A system for adjusting the output of multiple integrated illuminated panels may include a plurality of illumination sources in operative connection with a plurality of the integrated illuminated panels, the plurality of illumination sources being disposed within a cockpit. The system may further include a dimming control configured to provide manual adjustment of brightness of the plurality of illumination sources, and a digital controller configured to automatically harmonize chromaticity and brightness of the plurality of illumination sources based on detected ambient lighting conditions.

### BRIEF DESCRIPTION OF THE DRAWINGS

The present invention will now be described, by way of example, with reference to the accompanying drawings, wherein like reference numerals identify like components in the several figures, in which:

FIG. 1 is a block diagram generally illustrating the design process for an embodiment of an adaptive optics system.

FIG. 2 is a system block diagram generally illustrating an embodiment of a digital adaptive optics system of multiple panels.

FIGS. 3A and 3B are graphs generally illustrating configurability of nonlinear dimming control curves.

FIG. 4A is a graph generally illustrating dynamic dimming control characteristics of a dimming potentiometer relative to control panel assembly luminance.

FIG. 4B is a graph generally illustrating dimming control characteristics of the potentiometer of FIG. 4A at the turn-off position.

FIG. 5 is an exemplary integrated illuminated cockpit panel generally illustrating various legend and symbol sizes that require light harmonization and balancing.

FIG. 6 generally illustrates an exemplary set of luminance and contrast parameters of indication and identification lights of an exemplary cockpit lighting arrangement.

FIG. 7 generally illustrates exemplary chromaticity parameters of indication and identification lights of an exemplary airplane cockpit.

### DETAILED DESCRIPTION

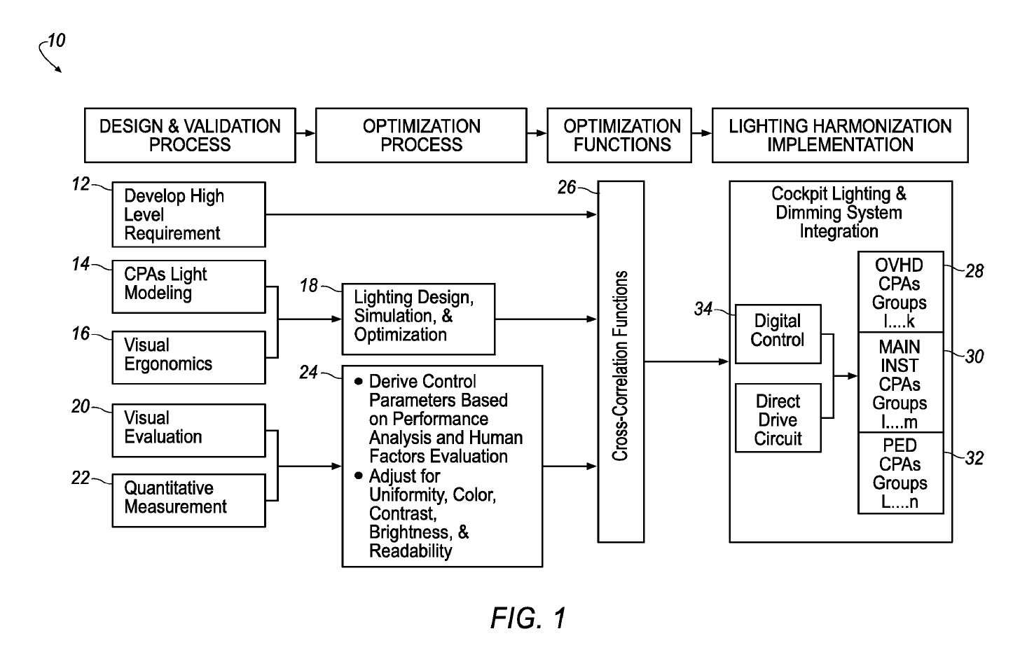

FIG. 1 is a block diagram illustrating the design process for an embodiment of an adaptive optics system 10. An adaptive optics system, such as system 10, optimizes and harmonizes the chromaticity (color) and brightness of the illumination sources in a cockpit. The term “cockpit” can be used to refer to cockpits employed in vehicles or other command and control structures, including, without limitation, aerospace applications. An adaptive optics system 10 is especially desirable in a cockpit with multiple integrated control panel assemblies (CPAs), which may have multiple independent illumination sources that need to be adjusted and harmonized for a particular application (i.e., airplane, car, or boat), a particular user (i.e., an airplane pilot), and/or particular ambient light conditions. Because the level of ambient light affects the appearance of colors and contrast, as well as desired brightness, system 10 may optimize brightness and chromaticity for several modes of operation. System 10 may select between modes based on the time of day, based on user selection, or based directly on the actual ambient light level. For example, system 10 may have a day mode, a semi-dark night mode, and a dark night mode, where each mode has different settings for brightness and chromaticity.

Designing and optimizing an adaptive optics system according to the present invention may include several steps and sub-steps, many of which are shown as blocks in FIG. 1. At block 12, high-level requirements for a particular application are developed. For example, in an aircraft cockpit application, high-level requirements may include the number and location of displays, indicators, and warning lights, as well as the desired color palette and desired brightness for several modes of operation for those displays, indicators, and warning lights. The high-level requirements may differ for separate applications. For instance, an aircraft cockpit may have different high-level requirements than a car passenger cabin, and one aircraft cockpit may have different high-level requirements than another aircraft cockpit. High-level requirements for an adaptive optics system generally may include any aspect of cockpit design related to the position and appearance of illuminated components.

The high-level requirements are first implemented and tested in a virtual environment at blocks 14, 16, and 18. At block 14, the high-level requirements are translated into lighting parameters for individual CPAs, which are virtually designed and simulated to compare and adjust the relative brightness levels of each CPA. At block 16, ambient light is incorporated into the virtual environment, and the visual ergonomics of the brightness and color palette are assessed for various ambient lighting conditions. At block 18, the brightness and color palette for individual CPAs are optimized in digital simulation by recursively adjusting lighting parameters and assessing the appearance of each CPA and/or the harmonization of the entire system.

At blocks 20, 22, and 24, a physical model of the system of integrated CPAs is built and the parameters that were optimized in digital simulation at blocks 14, 16, and 18 are tested. At block 20, a subjective human visual evaluation of the system is performed, noting the appearance and harmonization of the system at various dimming levels and ambient lighting conditions. At block 22, quantitative measurements of, inter alia, ambient light, CPA brightness, and CPA colors are taken to translate the human visual evaluation into adjustable data and repeatable lighting parameters. Based on the human visual evaluation and associated quantitative measurements, at block 24 the system parameters are again recursively assessed, adjusted, and optimized—this time in the physical model. Individual CPAs are adjusted for, inter alia, uniformity, color, contrast, brightness, and readability. Each CPA may have its own set of brightness and color parameters as a result of the physical modeling and the computer simulation.

System 10 may be optimized and harmonized for several modes of operation associated with varying levels of ambient light. Accordingly, both the virtual model at blocks 14, 16, and 18 and the physical model at blocks 20, 22, and 24 may be recursively assessed, adjusted, and optimized for several discrete modes of operation, or for a continuum of ambient light levels. Accordingly, each CPA may have separate brightness and color parameters for separate modes, satisfying the need for different CPA illumination settings for different ambient light conditions. For example, but without limitation, system 10 may have a day mode, a semi-dark night mode, and a night mode, each with its own color palette and brightness settings for each CPA.

The individual CPA lighting parameters are used to develop one or more cross-correlation functions at block 26. The cross-correlation functions reconcile the lighting parameters of the individual CPAs to optimize and harmonize lighting conditions among the plurality of illumination sources in operative communication with the several CPAs. CPAs may be grouped into zones based on their locations in the cockpit. In an aircraft cockpit embodiment, CPA zones may include overhead (OVH) CPAs 28, main instrument (MAIN INST) CPAs 30, and pedestal (PED) CPAs 32. The output of the cross-correlation functions 26 are the lighting parameters for the each CPA zone, as well as the individual CPAs within each zone. The lighting parameters for a CPA may include a color palette for each mode and a dimming scheme for each mode. The dimming scheme for a CPA may be a dimming curve—the relationship between the position of a manual dimming control reference and the brightness of the CPA—and/or a set of brightness values. The output of the cross-correlation functions, or the functions themselves, may be stored in memory within system 10. The function outputs may be fed into a digital pulse-width modulation (PWM) controller 34, or may be fed into a direct drive circuit. If implemented, a direct drive circuit would control the system based on adjusting the power supplied to each CPA light source, rather than by PWM.

It should be understood that, as used herein, “optimization” may be a subjective determination, an objective determination, or a combination of subjective and objective factors. By accounting for both subjective impressions and objective measurements, system 10 incorporates both science and psychology into the design of a cockpit environment, advantageously resulting in a lighting scheme that is both highly visible to the user and safe for long working hours.

FIG. 2 is system block diagram illustrating generally an embodiment of a digital control system architecture of an adaptive optics system 10 resulting from the design procedure and control of FIG. 1. The systematic configuration in FIG.2 discloses control process and overall relation among various technical components. System 10 includes one or more dimming references 36, a multiple channel analog-to-digital converter 38, memory-stored cross-correlation functions 26, and digital PWM controller 34. Dimming references 36 may include, without limitation, the position of one or more manual dimming controls, an ambient lighting reference, and other manually-adjusted settings. Dimming controls may be, for example, but without limitation, potentiometers (POTs), switches, knobs, and sliding controls. The ambient lighting reference may be input manually by a user, or may be determined by system 10 based on an actual level of ambient light detected by an ambient light sensor. Dimming references 36 are provided to or fed into A/D converter 38, which inputs the digitized dimming references to cross-correlation functions 26. Cross-correlation functions 26 associate dimming reference settings with individual CPA zones and assigns lighting parameters (dimming scheme and color) for each CPA zone, as well as for individual CPAs within each zone. The lighting parameters from the cross-correlation functions are input to digital controller 34, which can adjust the brightness and color of each CPA and/or each CPA zone according to the parameters.

In the embodiment of FIG. 2, digital controller 34 may include separate DSP-based digital chromaticity pulse-width modulation (PWM) for each CPA zone (shown at blocks 40), and for each individual CPA (blocks 42). The digital chromaticity control approach, according to an embodiment of the present invention, may be employed for, among other things, dimming, color (spectrum) balance, and harmonization. Digital controller 34 may also adjust chromaticity by injecting different amounts of different colors (such as red, green, and blue) into the color palette for different modes of operation. The color injection may include:

(a) producing a desirable amount of light flux of each light component by a digital modulation; the digital modulation may be achieved by pulse-width modulation, for example, by controlling the average voltage as applied to the light device producing single-visible light sources, respectively—this may be for a first light-spectra modulation by changing the ratio of the light flux of the visible light components;

(b) distributing the desirable amount of light flux of each of the light components by a proper geophysical distribution/layout for a second light-spectrum modulation; and

(c) incorporating the digital modulation in an integrated DSP controller or microcontroller circuit (MPU) including, without limitation, a TMS320C2812 MPU.

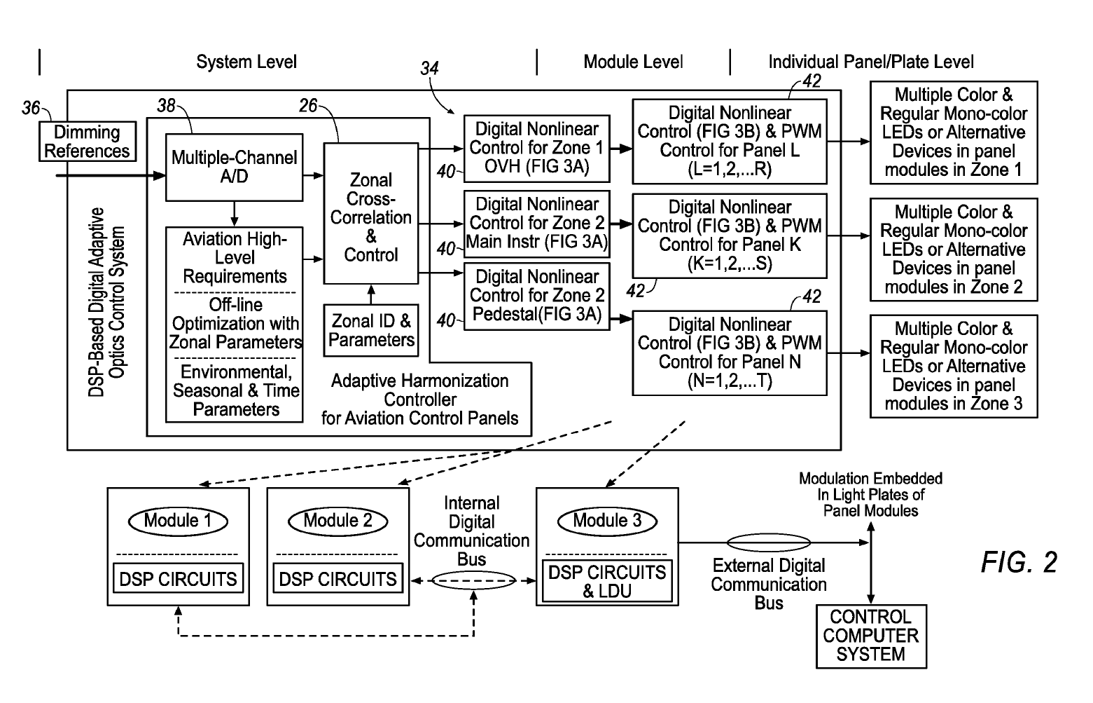

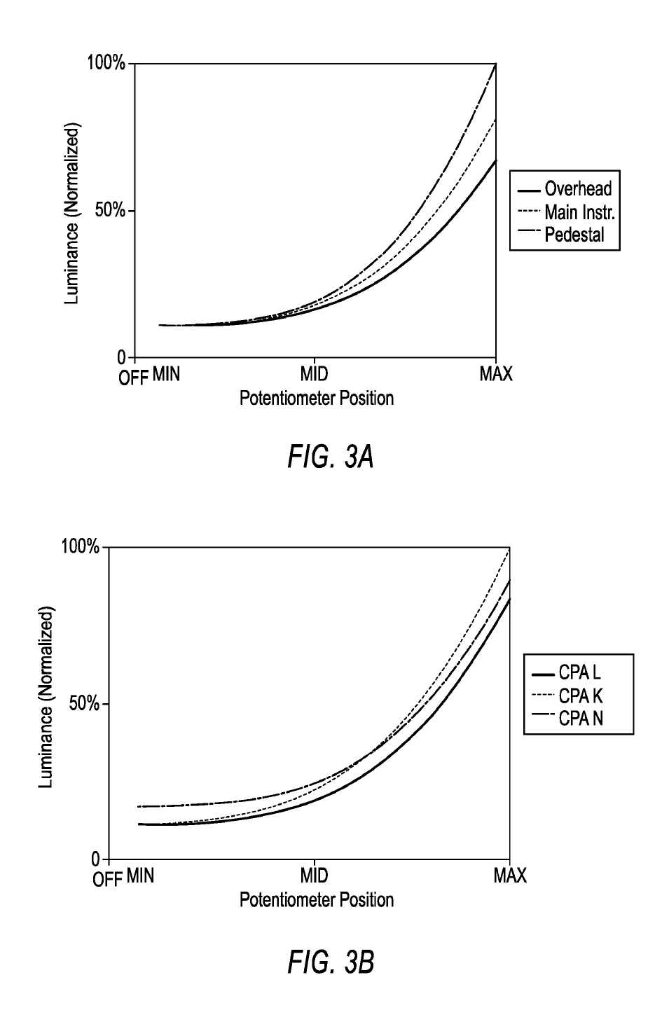

Each CPA zone may have its own digital control scheme for both chromaticity and brightness, and each CPA within each zone may have its own control scheme. For instance, overhead CPA zone 28 may have R different control schemes for R different CPAs such that CPA Lₓ has dimming scheme Dₓ, where (x=1, 2, . . . , R). Each control scheme may have its own dimming curve, individually configured for a harmonized system. FIGS. 3A and 3B illustrate the configurability of dimming curves. In the embodiment of FIG. 3A, three different CPA zones have separate dimming curves, where each curve is applied uniformly to an entire CPA zone. In the embodiment of FIG. 3B, three separate CPAs (L, K, N) within a single zone have different dimming curves. The embodiments of FIG. 3A and FIG. 3B may be combined, such that separate CPA zones have separate default dimming curves with variation from the default for some CPAs within each zone. Furthermore, one or more manual dimming controls may be provided, some or all of which may be act as dimming references 36 as generally shown in FIG. 2. A single master dimming control may control all CPA zones, with separate dimming curves associated with each CPA zone or each CPA, such that the master dimming control increases and decreases the brightness of different CPAs at different rates. Local dimming controllers may also be provided that, when active, increase and decrease the brightness of a single CPA zone according to a single dimming curve, or according to several dimming curves assigned to individual CPAs. A combination of a master dimming control and one or more local dimming controls may also be employed.

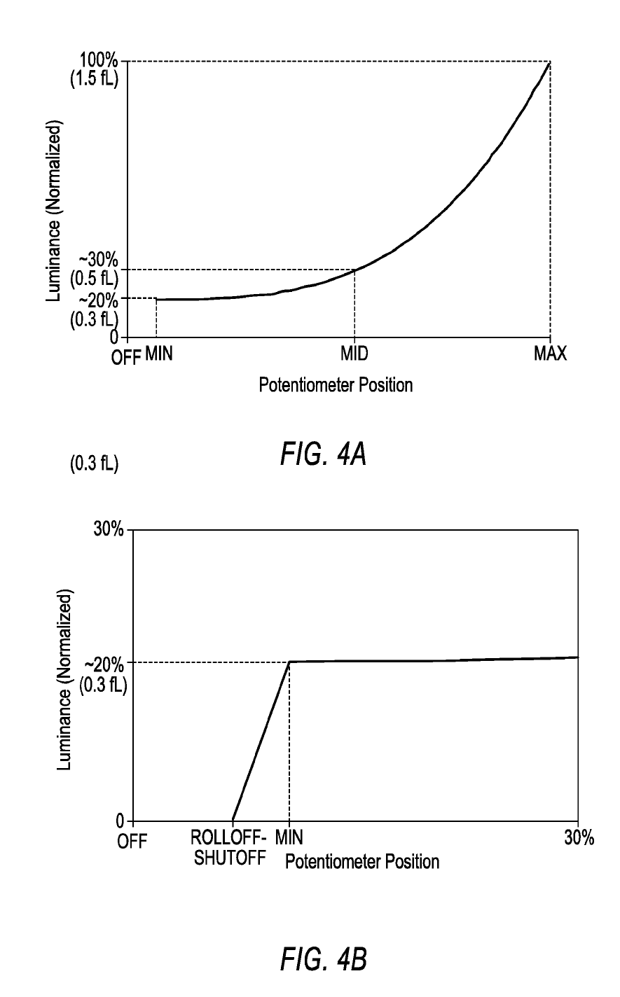

FIGS. 4A and 4B illustrate an embodiment of a non-linear dimming curve associated with a dimming POT. In the exemplary embodiment of FIGS. 4A and 4B, the dimming curve is exponential, which may provide greater low-level dimming control than a linear dimming curve. The embodiment of FIGS. 4A and 4B achieves maximum luminance of 1.5 fL at the maximum dimming control position, luminance of 0.3 fL at the minimum dimming control position (i.e., the position at which any further decrease will result in zero luminance), and a luminance of 0.5 fL at a dimming control position midway between the maximum and minimum. Turning the dimming POT below its minimum position in the embodiment of FIGS. 4A and 4B turns the controlled visible illumination sources off (e.g., 0.0 fL indicated at Roll-Off/Shut-Off).

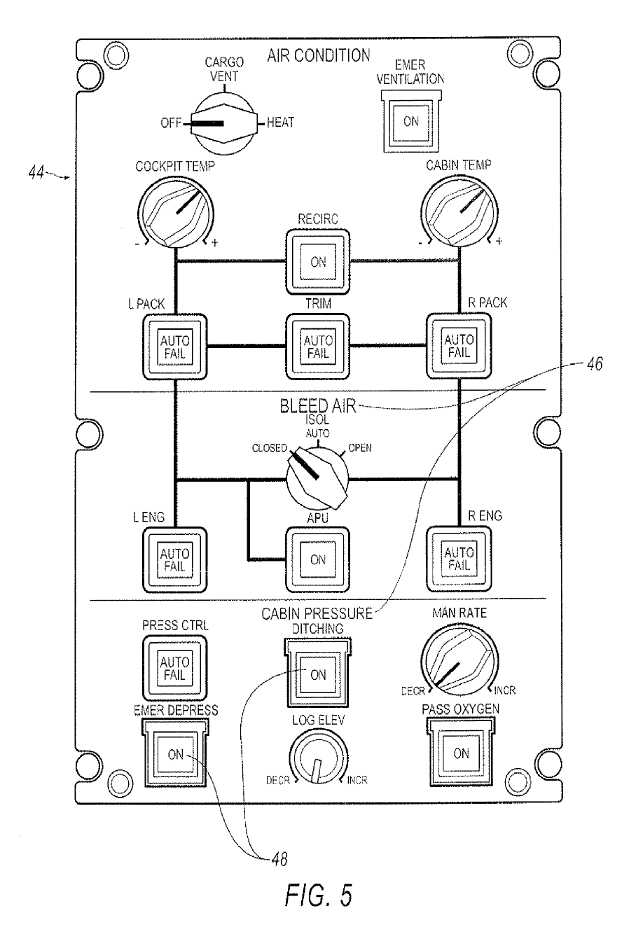

FIG. 5 is an exemplary integrated illuminated cockpit panel 44 illustrating various legend and symbol sizes that require light harmonization and balancing. Identification lighting 46, which may identify what a particular CPA, knob, or button controls, may require a different brightness and color palette than indication lighting 48, which indicates the state of a particular system or measurement. Both identification lighting 46 and indication lighting 48 may require different brightness during a bright day than during a dark night, and may require different colors as well. By adjusting the brightness and chromaticity of different sub-sections of panel 44, system 10 harmonizes the colors and light sources of panel 44, along with other panels, for a less distracting, and therefore safer and more desirable appearance.

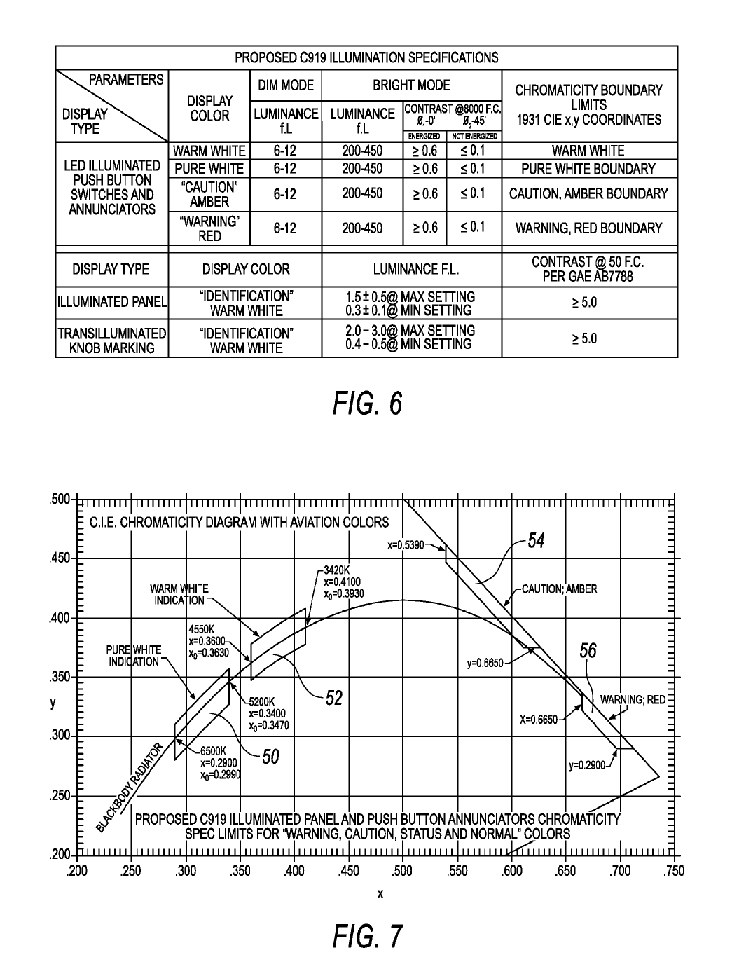

FIG. 6 illustrates exemplary luminance and contrast parameters of the indication and identification lights for an airplane cockpit. As shown in FIG. 6, luminance and contrast parameters are typically displayed in table form, in which they can be easily adjusted. Parameters such as brightness, color, ON contrast, OFF contrast, uniformity, font type, and character/symbol size may be displayed in a table and may be available for manual adjustment from within the cockpit.

FIG. 7 illustrates exemplary chromaticity parameters of the indication and identification lights of an exemplary airplane cockpit. Color selection zones 50, 52, 54, and 56 define exemplary display colors. For example, but without limitation, color zone 52 (“Warm White”) may be applied to identification lighting 46. One of color zones 50 (“Pure White”), 54 (“Caution: Amber”), and 56 (“Warning: Red”) may be applied to indication lighting 48.

It is noted that the drawings are intended to illustrate various concepts associated with the disclosure and are not intended to so narrowly limit the invention. A wide range of changes and modifications to the embodiments described above will be apparent to those skilled in the art, and are contemplated. It is therefore intended that the foregoing detailed description be regarded as illustrative rather than limiting, and that it be understood that it is the following claims, including all equivalents, that are intended to define the spirit and scope of this invention.

What is claimed:

1. A system for adaptively controlling and adjusting the output and balance of multiple integrated control panel assemblies, the system comprising:
a plurality of illumination sources in operative connection with a plurality of integrated control panel assemblies, the plurality of illumination sources being disposed within a cockpit;
a digital controller configured to automatically harmonize brightness and chromaticity of the plurality of illumination sources based on detected ambient lighting conditions; and
a dimming control configured to provide manual adjustment of brightness of the plurality of illumination sources.

2. The system of claim 1, wherein the digital controller is configured to harmonize brightness the plurality of control panel assemblies based on the output of one or more zonal or control panel assembly cross-correlation functions.

3. The system of claim 2, wherein the one or more cross-correlation functions are created based on a digital model of the plurality of illumination sources and on a physical model of the plurality of illumination sources.

4. The system of claim 1, wherein adjustment of the dimming control has a non-linear relationship with the brightness of the plurality of illumination sources.

5. The system of claim 1, wherein adjustment of the dimming control has an exponential relationship with the brightness of the plurality of illumination sources.

6. The system of claim 5, wherein a first subset of the plurality of illumination sources is adjusted according to a first exponential relationship, and a second subset of the plurality of illumination sources is adjusted according to a second exponential relationship.

7. The system of claim 6, wherein the first exponential relationship is not equal to the second exponential relationship.

8. The system of claim 1, wherein the digital controller is configured with separate brightness settings and chromaticity settings for each of a dark night mode, a semi-dark night mode, and a day mode.

9. The system of claim 8, wherein the chromaticity settings for each of the dark night mode, the semi-dark night mode, and the day mode include different amounts of red, green, and blue colors.

10. The system of claim 1, wherein the plurality of illumination sources comprise identification lighting, indication lighting, and flood lighting.

11. The system of claim 1, wherein chromaticity is harmonized by individually adjusting the intensity of red, green, and blue colors.

12. The system of claim 1, wherein the digital controller adjusts brightness and chromaticity of the plurality of illumination sources by pulse-width modulation.

13. The system of claim 1, wherein the digital controller is configured to adjust brightness and chromaticity of the plurality of illumination sources based on one or more adjustable settings selected from the group consisting of:
brightness;
chromaticity;
contrast;
uniformity;
font type; and
character size.

14. A system for adjusting the output of multiple integrated illuminated panels, the system comprising:
a plurality of integrated illuminated panels in a vehicle cockpit;
a dimming control configured to provide manual adjustment of the brightness of the multiple integrated illuminated panels; and
a digital controller configured to automatically adjust brightness and chromaticity of the multiple integrated illuminated panels based on an output of one or more cross-correlation functions, the one or more cross-correlation functions receiving detected ambient lighting conditions as input.

15. The system of claim 14, wherein the one or more cross-correlation functions take as further input a reference based on the position of the dimming control.

16. The system of claim 14, wherein the one or more cross-correlation functions are individually optimized for each of a day mode, a semi-dark night mode, and a dark night mode.

17. A method of adjusting the output of multiple integrated illuminated panels, the method comprising:
providing a computer-based model set of integrated illuminated panels;
recursively adjusting and assessing the brightness and chromaticity of the computer-based model set of integrated illuminated panels to create a first set of lighting parameters;
providing a physical model set of integrated illuminated panels;
recursively adjusting and assessing the brightness and chromaticity of the physical model set of integrated illuminated panels to create a second set of lighting parameters;
establishing a set of functions based on the first set of lighting parameters and the second set of lighting parameters;
storing the established functions in memory;
inputting a manual dimming control reference and an ambient light reference to the functions; and
adjusting the brightness and chromaticity of the multiple integrated illuminated panels based on the output of the established functions.

18. The method of claim 17, wherein adjusting the brightness and chromaticity of the multiple integrated illuminated panels is performed by a digital controller.

19. The method of claim 17, wherein the manual dimming control reference is from a dimming potentiometer.

20. The method of claim 17, wherein assessing the brightness and chromaticity of the physical model set of integrated illuminated panels includes a human visual evaluation and a quantitative measurement.
